(19) United States
(12) Patent Application Publication
(10) Pub. No.: US 2022/0303030 A1
(43) Pub. Date: Sep. 22, 2022

(54) COMMUNICATION DEVICE AND COMMUNICATION METHOD

(71) Applicant: Panasonic Intellectual Property Corporation of America, Torrance, CA (US)

(72) Inventors: Jun MINOTANI, Ishikawa (JP); Yoshio URABE, Nara (JP); Takashi IWAI, Ishikawa (JP); Tomofumi TAKATA, Ishikawa (JP); Hiroyuki KANAYA, Ishikawa (JP); Ryutaro HASHI, Ishikawa (JP)

(21) Appl. No.: 17/638,146

(22) PCT Filed: Jul. 17, 2020
(86) PCT No.: PCT/JP2020/027930

§ 371 Date: Feb. 24, 2022

(30) Foreign Application Priority Data
Sep. 12, 2019 (JP) 2019-166253

(51) Int. Cl. H04B 17/24; H04B 7/06; H04B 7/0417

(52) U.S. Cl. CPC H04B 17/24; H04B 7/0617; H04B 7/0417; H04B 7/0697; H04B 7/0632; H04B 7/0452

(57) ABSTRACT

This communication device comprises: a control circuit that, on the basis of first information relating to the reception quality of a plurality of spatial streams, determines a spatial stream for feeding back second information; and a transmission circuit that transmits the second information relating to the determined spatial stream.

### TECHNICAL FIELD

The present disclosure relates to a communication apparatus and a communication method.

### BACKGROUND ART

The Task Group (TG) be has been developing the technical specification of the Institute of Electrical and Electronics Engineers (IEEE) 802.11be (hereinafter, referred to as “11be”) as the successor standard of 802.11ax (hereinafter, referred to as “11ax”), which is a standard of IEEE 802.11.

Discussions have been proceeding for 11be on the increase, from 11ax, in the maximum number of spatial streams (SSs), e.g., also referred to as the number of spatial multiplexing, in downlink (DL) multi-user multiple-input multiple output (MU-MIMO), for example. The increase in the maximum number of spatial streams improves spectrum efficiency.

### CITATION LIST

### Non Patent Literature

NPL 1
IEEE 802.11-19/0828r3, feedback-overhead-analysis-for-16-spatial-stream-minto, May, 2019
NPL 2
IEEE P802.11ax D4.0, February 2019
NPL 3
IEEE Std 802.11, 2016

### SUMMARY OF INVENTION

There is scope for further study, however, on a method of controlling spatial multiplexing processing.

One non-limiting and exemplary embodiment facilitates providing a base station, a terminal, and a communication method each capable of improving efficiency of processing on feedback of information by a communication apparatus that receives spatially multiplexed streams.

A communication apparatus according to an embodiment of the present disclosure includes: control circuitry, which, in operation, determines a spatial stream based on first information, the spatial stream being subject to feedback on second information, and the first information being information on reception quality of a plurality of spatial streams including the spatial stream; and transmission circuitry, which, in operation, transmits the second information on the determined spatial stream.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve efficiency of processing on feedback of information by a communication apparatus that receives spatially multiplexed streams.

Additional benefits and advantages of the disclosed embodiments will become apparent from the specification and drawings. The benefits andlor advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a sequence diagram describing exemplary beamforming by null data packet (NDP) sounding and explicit feedback;

FIG. 2 illustrates an exemplary High efficiency (HE) Compressed Beamforming/channel quality indicator (CQI) frame action field format;

FIG. 3 is a sequence diagram describing exemplary staggered sounding;

FIG. 4 is a block diagram illustrating an exemplary configuration of a part of an STA according to Embodiment 1;

FIG. 5 is a block diagram illustrating an exemplary configuration of an AP according to Embodiment 1;

FIG. 6 is a block diagram illustrating an exemplary configuration of the STA according to Embodiment 1;

FIG. 7 is a sequence diagram describing an exemplary operation of a radio communication system according to Embodiment 1;

FIG. 8 is a flowchart describing an exemplary operation for determining feedback information according to Embodiment 1;

FIG. 9 illustrates an exemplary system configuration according to Embodiment 1;

FIG. 10 illustrates an exemplary HE Compressed Beamforming/CQ1 frame action field format according to Method 1-1;

FIG. 11 illustrates an exemplary HE Action field according to Method 1-2;

FIG. 12A illustrates an exemplary frame format according to Method 1-2;

FIG. 12B illustrates another exemplary frame format according to Method 1-2;

FIG. 12C illustrates still another exemplary frame format according to Method 1-2;

FIG. 12D illustrates still another exemplary frame format according to Method 1-2;

FIG. 13A illustrates an exemplary BA frame format according to Method 1-3;

FIG. 13B illustrates an exemplary operation of transmitting a response signal according to Method 1-3;

FIG. 14A illustrates another exemplary BA frame format according to Method 1-3;

FIG. 14B illustrates another exemplary operation of transmitting a response signal according to Method 1-3;

FIG. 15 is a sequence diagram describing an exemplary operation according to Method 1-4;

FIG. 16 is a sequence diagram describing an exemplary operation according to Method 1-5;

FIG. 17 is a block diagram illustrating an exemplary configuration of an AP according to Embodiment 2;

FIG. 18 is a block diagram illustrating an exemplary configuration of an STA according to Embodiment 2;

FIG. 19 illustrates an exemplary system configuration according to Embodiment 2; and

FIG. 20 illustrates exemplary relative amplitude accuracy according to Embodiment

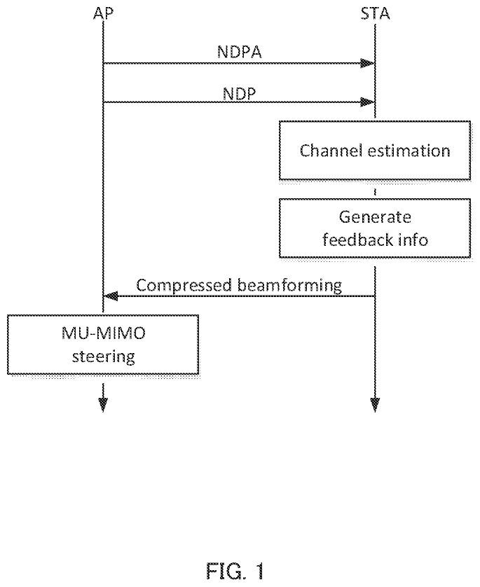

### DESCRIPTION OF EMBODIMENTS

Hereinafter, embodiments of the present disclosure will be described in detail with reference to the accompanying drawings.

In the 802.11 standard, for example, when Space-Time Block Coding (STBC) is not performed, a single modulation symbol stream is generated from a single bit stream, and when the space-time block coding is performed, two or more modulation symbol streams are generated from a single bit stream. For example, a spatially multiplexed bit stream may be referred to as a “spatial stream” and a spatially multiplexed modulation symbol stream may be referred to as a “space-time stream (STS)”, and they could be distinguished from each other. When the space-time block coding is not performed, for example, the number of space-time streams is equal to the number of spatial streams.

The following description is about an example in which the space-time block coding is not performed. In other words, the spatial stream and the space-time stream are not distinguished in the following description, and the “spatial stream” refers to a spatial channel used for spatial multiplexing. The spatial stream in the following description, however, may be interpreted as the space-time stream when the space-time block coding is performed.

[Beamforming]

A beamforming technique is used in the DL MU-MIMO. The beamforming technique improves communication quality in DL.

In the DL MU-MIMO beamforming, for example, weighting (e.g., also referred to as “steering”, “spatial mapping” or “transmission precoding”) to control the amplitude and phase is performed to give orthogonality to signals addressed to respective users. A matrix indicating the weighting (hereinafter, referred to as a “steering matrix”) can be derived, for example, based on information of a propagation path (e.g., also referred to as a “channel”) estimated by the beamforming.

The amount of the propagation path information in the DL MU-MIMO increases in proportion to, for example, the maximum number of spatial streams, and thus studies have been carried out on a method of improving efficiency of the beamforming in 11be, in which the maximum number of spatial streams is possibly increased (see, for example, NPL 1).

11ax supports a method of using NDP sounding (or also referred to as NDP feedback sequence) and explicit feedback as an example of beamforming techniques (see, for example, NPL 2). FIG. I is a sequence diagram describing exemplar, 7 beamforming by the NDP sounding and explicit feedback.

In FIG. j1, an access point (AP, also referred to as a “base station”) transmits an NDP announcement (NDPA) to each terminal (e.g., also referred to as a “station (STA)”), for example. The AP indicates transmission of an NDP to the STA by transmitting the NDPA.

The AP transmits the NDP to the STA following the NDPA.

After receiving the NDP, the STA estimates a channel based on a signal (e.g., non-legacy long training field (non-legacy LTF)) included in the NDP.

Note that, when a steering matrix is added to the non-Legacy LTF, for example, the

STA may estimate a channel including a steering matrix (e.g., also referred to as an “effective channel”) regardless of whether the received signal is an NDP or a non-NDP. The following description simply uses the term “propagation path. response” (also referred to as a “propagation path characteristic”, “channel response”, “channel estimate matrix”, or “channel matrix”) regardless of whether it is a channel or an effective channel. The STA determines feedback information to transmit to the AP in response to the NDP, based on the channel estimate, for example.

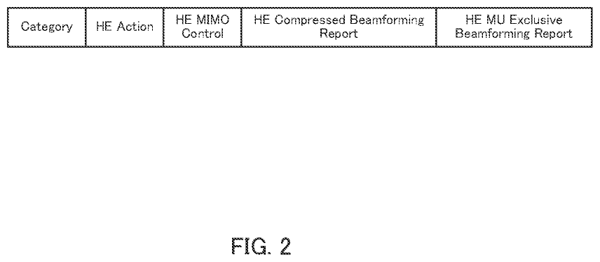

FIG. 2 illustrates an exemplary configuration of the feedback information transmitted. from the STA to the AP. FIG. 2 illustrates an exemplary Compressed Beamforming/CQI frame action field format, by way of example.

The “HE MIMO Control” illustrated in FIG. 2 may include, for example, a feedback control signal. The “HE Compressed Beamforming Report” illustrated in FIG. 2 may include, for example, information such as reception quality (e.g., mean signal-to-noise ratio (SNR)) for each spatial stream or a feedback matrix the information amount of which is compressed by a specified method. The “HE MU Exclusive Beamforming Report” illustrated in FIG. 2 may include, for example, information such as a difference between the SNR of each subcarrier and the mean SNR of the spatial stream to which each subcarrier belongs.

By way of example, the following description uses the term “feedback information (or also referred to as a feedback signal)” for the information included in the HE Compressed Beamforming/CQI frame Action field format illustrated in FIG. 2, such as the feedback control signal, the feedback matrix, and the SNR related to the spatial stream and the subcarrier. The information corresponds to, for example, the second information.

For example, when the AP transmits an NDP including N_{STS} spatial streams to the STA, the STA possibly estimates a channel with the size of N_{RX}×N_{STS}. Note that N_{RX} indicates the number of reception antennas of the STA. In this case, the size (Nᵣ×N_{c}) of the feedback matrix to be included in the feedback information by the STA may he determined, for example, according to following Expression 1:

[1]

Nᵣ=N_{STS}, N_{c}=min (N_{STS}, N_{RX}) (Expression 1).

The AP may, for example, perform scheduling for the STA based on the feedback information transmitted from the STA. In the scheduling, the AP may determine resource allocation information or a transmission parameter for the destination STA or each STA, for example.

In addition, when performing multi-user transmission (e.g., also referred to as “MU-MIMO transmission”), for example. the AP may derive a steering matrix based on the feedback information received from a plurality of STAs. The AP may transmit downlink (DL) data (e.g., referred to as a DL MU physical layer convergence procedure protocol data unit (DL MU PPDU)) to the STAs using the steering matrix, for example.

Further, 802.11n also supports “Staggered sounding” as another example of beamforming techniques (see. for example, NPL 3).

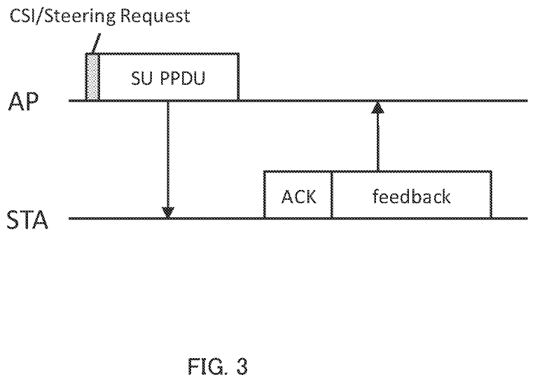

FIG. 3 is a sequence diagram describing an exemplary operation of the staggered sounding.

The staggered sounding is a beamforming technique for single-user MIMO (SU-MIMO). An AP, for example, transmits a signal (e.g., SU PPDU) including a data portion (e.g., also referred to as a data field) to an STA. The STA determines whether to transmit feedback information, for example, based on channel state information (CSI)/Steering Request included in the medium access control (MAC) layer of the signal transmitted from the AP. When transmission of the feedback information is indicated (feedback information transmission: Yes), for example, the STA feeds back a channel estimate obtained based on the signal (e.g., non-legacy LTE) included in the signal transmitted from the AR For example, the STA may add the channel estimate (in other words, feedback information) to a response signal (e.g., Acknowledgement (ACK) or Block ACK (BA)), and transmit the signal to the AP based on a feedback method indicated in the CSI/Steering Request.

However, transmission efficiency is possibly decreased with increased overhead of the feedback information when, for example, the beamforming with the NDP sounding and the Explicit feedback is performed for each STA every time the AP calculates (i.e., updates) a steering matrix.

Additionally, the AP may not be able to properly determine the timing of updating the steering matrix. For example, the steering matrix need not be updated when there is little change in a propagation path response, which is also referred to as, for example, channel fading (e.g., when the amount of change in the propagation path response is less than a threshold). Thus, in a case where the beamforming with the NDP sounding and the Explicit feedback is performed when the amount of the change in the propagation path response is less than the threshold, feedback information is possibly transmitted in vain and the transmission efficiency is decreased.

An exemplary embodiment of the present disclosure describes a method of improving the transmission efficiency m spatial multiplexing transmission such as MU-MIMO transmission. For example, a description will be given of a technique for improving the efficiency of processing on feedback of information by a communication apparatus that receives spatially multiplexed streams.

### Embodiment 1

[Configuration of Radio Communication System]

A radio communication system according to an embodiment of the present disclosure includes at least one AP 100 and a plurality of STAs 200.

In DL communication(e.g., transmission and reception of DL data), for example, AP 100 (or also referred to as a “downlink radio transmitter”) may perform DL MU-MIMO transmission to the plurality of STAs 200 (or also referred to as “downlink radio receivers”). Each of STAs 200 may, for example, generate feedback information based on a signal transmitted by the DL MU-MIMO (e.g., also referred to as DL MU PPDU), and transmit the feedback information to AP 100 (e.g., uplink (UL) SU transmission or UL MU transmission).

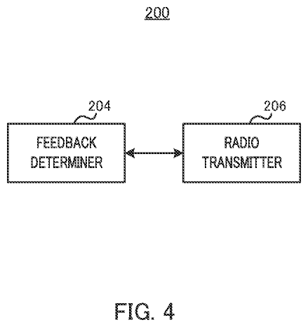

FIG. 4 is a block diagram illustrating an exemplary configuration of a part of STA 200 according to an embodiment of the present disclosure. In STA 200 (e.g., corresponding to a communication apparatus) illustrated in FIG. 4, feedback determiner 204 (e.g., corresponding to control circuitry) determines, based on the first information on reception quality of a plurality of spatial streams, a spatial stream to be subject to feedback on the second information (e.g., stream information). Radio transmitter 206 (e.g., corresponding to transmission circuitry) transmits the second information on the determined spatial stream.

<Exemplary Configuration of AP 100>

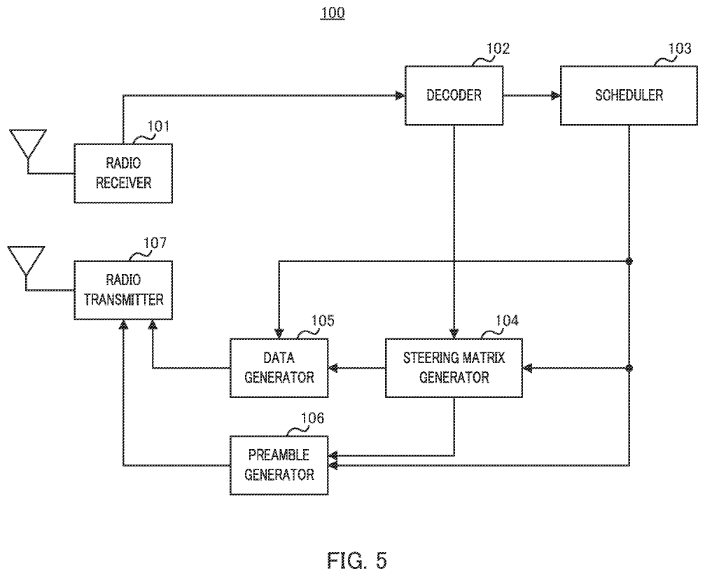

FIG. 5 is a block diagram illustrating an exemplary configuration of AP 100. AP 100 illustrated in FIG. 5 includes, for example, radio receiver 101, decoder 102, scheduler 103, steering matrix generator 104, data generator 105, preamble generator 106, and radio transmitter 107.

Radio receiver 101 receives a signal transmitted from STA 200 via an antenna, and performs radio reception processing such as down-conversion and AID conversion on the received signal. For example, radio receiver 101 separates the received signal after the radio reception processing into, for example, a preamble portion (also called a preamble signal) and a data portion (also called a data signal), and outputs the signals to decoder 102.

Decoder 102, for example, performs processing such as a Fast Fourier Transform (FFT) on each of the preamble signal and the data signal inputted from radio receiver 101.

Decoder 102 extracts, for example, a control signal (e.g., frequency bandwidth, modulation and channel coding scheme (MCS), or coding method) included in the preamble signal. In addition, decoder 102 performs channel estimation using, for example, a reference signal included in the preamble signal. For example, decoder 102 may generate a channel estimate matrix based on a result of the channel estimation. The channel estimate matrix may be represented by, for example, a matrix of (N_{RX}×Nₛₛ), where Nₛₛ corresponds to the number of streams and N_{RX} corresponds to the number of reception antennas of AP 100.

Decoder 102, for example, based on the control signal extracted from the preamble signal, and the channel estimate matrix, performs channel equalization on the data signal after the FFT, demodulates and decodes the data signal, and performs error determination such as a Cyclic Redundancy Check (CRC). When no error (i.e., decoding error) is included in the data signal, decoder 102 outputs the decoded data signal to scheduler 103 and steering matrix generator 104, for example. When an error is included in the data signal, decoder 102 does not output the decoded data signal, for example.

Scheduler 103 performs scheduling (i.e., DL scheduling) for STA 200 based on the data signal (e.g., including a response signal or feedback information) inputted from decoder 102. For example, scheduler 103 may determine whether to perform MU-MIMO transmission. When performing the MU-MIMO transmission, scheduler 103 may determine RU allocation to each STA 200 (e.g., user) and may determine spatial stream allocation to each STA 200, based on the data signal inputted from decoder 102. Scheduler 103 outputs information on the determined scheduling to steering matrix generator 104, data generator 105, and preamble generator 106.

Steering matrix generator 104 generates a steering matrix based on the scheduling information inputted from scheduler 103. The steering matrix is, fir example, a matrix to give orthogonality to MU-MIMO signals.

In addition, when a data signal including feedback information (e.g., channel estimate or singular vector) is inputted from decoder 102, steering matrix generator 104 may newly generate a steering matrix or may update a part of the held steering matrix, based on the feedback information. Meanwhile, when a data signal including feedback information is not inputted from decoder 102, steering matrix generator 104 may generate a steering matrix based on feedback information held for each destination STA 200 (i.e., user). When steering matrix generator 104 does not hold the feedback information of destination STAs 200, steering matrix generator 104 may configure a predetermined orthogonal matrix (e.g., identity matrix or Hadamard matrix) to be the steering matrix, for example.

Steering matrix generator 104 outputs, to data generator 105 and preamble generator 106, information on the steering matrix to be applied to the MU-MIMO transmission. in addition, steering matrix generator 104 stores the information on the steering matrix (e.g., feedback information) in a buffer (not illustrated.).

Data generator 105 generates a data sequence addressed to STA 200 based on the scheduling information inputted from scheduler 103. Data generator 105 encodes the generated data sequence based on the scheduling information. In addition, data generator 105 may add the information on the steering matrix inputted from steering matrix generator 104 to the encoded data sequence. Data generator 105, for example, assigns the data sequence (e.g., the sequence with the information on the steering matrix added thereto) to the scheduled. RU, and performs modulation and Inverse Fast Fourier Transform (IFFT) processing to generate a data signal, Data generator 105 outputs the generated data signal to radio transmitter 107.

Preamble generator 106 generates a preamble signal based on the scheduling information inputted from scheduler 103. For example, preamble generator 106 may add the steering matrix inputted from steering matrix generator 104 to a reference signal included in the preamble signal. Preamble generator 106 performs modulation and IFFT processing on the preamble signal, and outputs the preamble signal to radio transmitter 107.

Radio transmitter 107 generates a radio frame (i.e., packet signal) based on the data signal inputted from data generator 105 and the preamble signal inputted from preamble generator 106. Radio transmitter 107 performs radio transmission processing on the generated radio frame, such as D/A conversion, and up-conversion for carrier frequency, and transmits the signal after the radio transmission processing to STA 200 via, the antenna

<Exemplary Configuration of STA 200>

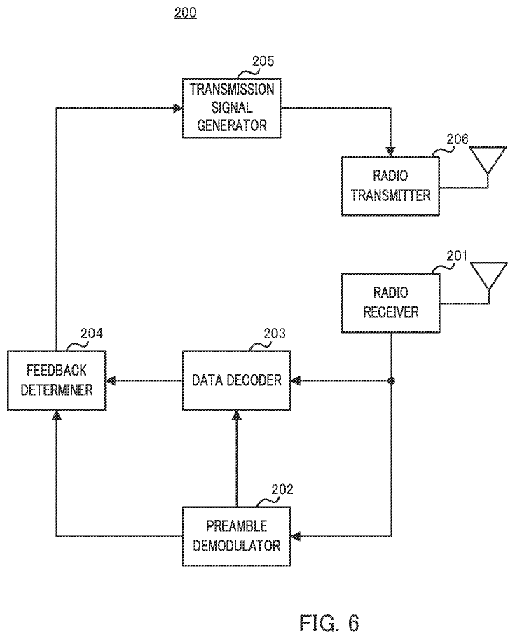

FIG. 6 is a block diagram illustrating an exemplary configuration of STA 200, STA 200 illustrated in FIG. 6 includes, for example, radio receiver 201, preamble demodulator 202, data decoder 203, feedback determiner 204, transmission signal generator 205, and radio transmitter 206.

Radio receiver 201 performs radio reception processing such as down-conversion and AID conversion on a signal received via an antenna Radio receiver 201 extracts a preamble signal from the signal after the radio reception processing, and outputs the signal to preamble demodulator 202. Radio receiver 201 also extracts a data signal from the signal after the radio reception processing, and outputs the signal to data decoder 203.

Preamble demodulator 202 performs demodulation processing such as FFT on the preamble signal inputted from radio receiver 201, and extracts, from the demodulated preamble signal, a control signal to be used for demodulation and decoding of the data signal, for example. Preamble demodulator 202 may also perform. channel estimation based on a reference signal included in the preamble signal. Preamble demodulator 202 outputs the extracted control signal and channel estimation information (e,g., channel estimate matrix) to data decoder 203. In addition, preamble demodulator 202 outputs the reference signal included in the preamble signal and the channel estimation information to feedback determiner 204.

Data decoder 203 performs processing such as FFT processing, channel equalization, or demodulation on the data portion inputted from radio receiver 201, for example, based on the control signal and the channel estimation information inputted from preamble demodulator 202, and extracts demodulation data addressed to STA 200. Additionally, data decoder 203 decodes the extracted demodulation data and performs error determination such as CRC. Data decoder 203 outputs the error result of the data signal to feedback determiner 204.

Feedback determiner 204 determines whether to feed back information on a spatial stream (e.g., stream information). In other words, feedback determiner 204 determines, for example, a spatial stream the stream information of which is fed back among a plurality of spatial streams in multi-user transmission. Note that the term “. . . determiner” may be interchanged with another term such as “. . . decider” or “. . . controller”.

For example, feedback determiner 204 generates reception quality information based on the error determination result of the data signal inputted from data decoder 203 and the reference signal included in the preamble inputted from preamble demodulator 202.

The reception quality information may include information such as an error determination result of a desired (or preferred) signal (e.g., signal addressed to STA 200), a signal to interference plus noise ratio (SINK) of the desired signal, a power value of an inter-user interference signal (e.g., signal addressed to an STA other than STA 200), a desired signal to undesired signal ratio (DUR) between the desired signal and the inter-user interference signal, the amount of change in power of desired signals or power of inter-user interference signals between the previous MU-MIMO signal and the current MU-MIMO signal, the amount of change between power of a desired signal in NDP sounding and power of a desired signal in a MU-MIMO signal, or the amount of change in power of inter-user interference signals, for example.

Feedback determiner 204 then determines, for example. Whether the reception quality generated based on the reference signal satisfies a predetermined threshold (i.e., condition).

When the reception quality satisfies the predetermined threshold, feedback determiner 204 determines, for example, to feed back (i.e., transmit) the stream information. When the reception quality does not satisfy the predetermined threshold, in contrast, feedback determiner 204 may determine, for example, not to transmit the stream information. Feedback determiner 204 may, for example, determine whether to feed back the stream information for each of the plurality of spatial streams in the multi-user transmission,

Feedback determiner 204, for example, generates feedback information including the stream information on the determined spatial stream, and outputs the feedback information to transmission signal generator 205. The stream information may include information such as information (e.g., STA-ID) for identifying destination STA 200 of the spatial stream the reception quality of which satisfies a predetermined threshold, information for identifying the spatial stream (e.g., index information of the spatial stream), the SNR of the spatial stream, and a feedback matrix, for example.

When no feedback information is inputted from feedback determiner 204, transmission signal generator 205 generates a data sequence including, for example, a response signal to AP 100. Meanwhile, when the feedback information is inputted from feedback determiner 204, transmission signal generator 205 may generate a data sequence including a response signal to AP 100 and the feedback information. Transmission signal generator 205 assigns the generated data sequence to a predetermined frequency resource. and performs modulation and IFFT processing to generate a data signal (e.g., transmission signal), in addition, transmission signal generator 205 adds a preamble to the data signal to generate a radio frame (packet signal), and outputs the radio frame to radio transmitter 206.

Radio transmitter 206 performs radio transmission processing on the radio frame inputted from transmission signal generator 205, such as D/A conversion, and up-conversion for carrier frequency, an d transmits the signal after the radio transmission processing to AP 100 via the antenna

[Exemplary Operations of AP and STA]

Next, exemplary operations of AP 100 and STA 200 according to the present embodiment will be described.

In the present embodiment, STA 200 feeds back, to AP 100, stream information corresponding to some of spatial streams of a data portion included in a non-NDP MU PPDU (e.g., MU PPDU including a data portion to be described later) in multi-user transmission, for example, based on reception quality information of a reference signal (e.g., LTF) included in the non-NDP MU PPDU.

The following description is about a method for STA 200 to generate feedback information based on some of stream information to feed back for a non-NDP MU PPDU transmitted from AP 100 in multi-user transmission (e.g., DL MU-MIMO transmission) in 11ax, by way of example.

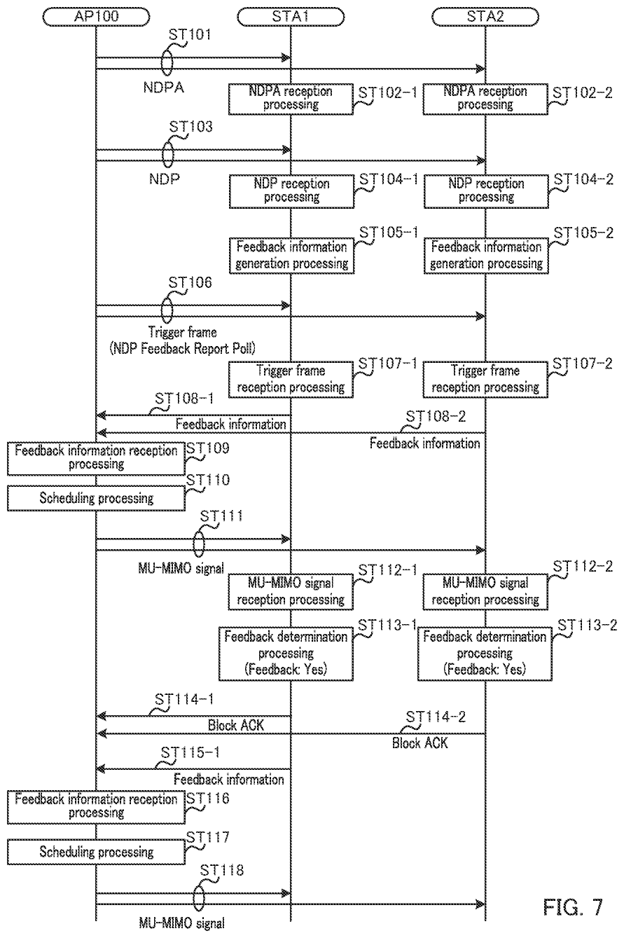

FIG. 7 is a sequence diagram describing an exemplary operation of a radio communication system on the DL MU-MIMO transmission.

By way of example, FIG. 7 illustrates an exemplary operation of DL MU-MTMO transmission ire AP 100 and two STAs 200 (e.g., STA 1 and STA 2). Note that the number of spatially multiplexed STAs in DL MU-MIMO transmission is not limited to two, and may be three or more.

In FIG. 7, AP 100 transmits NDPAs to STA 1 and STA 2, for example (ST101). The transmission of the NDPAs is an indication from AP 100 to STA 1 and STA 2 that NDPs are transmitted following the NDPAs.

STA 1 and STA 2 perform, for example, reception processing on the NDPAs (ST102-1 and ST102-2). For example, STA 1 and STA 2 may acquire, based on the NDPAs, control signals for compressing and feeding back propagation path information to be derived based on the NDPs to be transmitted by AP 100. The control signals may include feedback-related information, such as a bandwidth, a frequency resource (e.g., also referred to as a Resource Unit (RU)) index, a feedback type, the number of subcarrier groupings, or a codebook size, for example.

AP 100 transmits NDPs to STA 1 and STA 2, for example (ST103). DL MU transmission may be applied to the NDPs, for example. The DL MU transmission may be, for example, DL MU-MIMO transmission or DL Orthogonal Frequency-Division Multiple Access (OF⁻DMA) transmission.

STA 1 and STA 2 perform, for example, reception processing on the NDPs (ST104-1 and ST104-2). For example, STA 1 and STA 2 may perform channel estimation based on reference signals (e.g., LTFs) included in preamble portions of the NDPs.

STA 1 and STA 2 generate, for example, feedback information (ST105-1 and ST105-2), STA 1 and STA 2 may generate feedback information including information such as a feedback matrix or a mean SNR for each spatial stream, based on the control signals obtained from the NDPAs. The feedback matrix may include, for example, a channel estimate for each spatial stream or a singular vector obtained by applying singular value decomposition (SVD) to the channel estimate.

AP 100 transmits trigger frames to STA 1 and STA 2, for example (ST106). AP 100 may use trigger frames of NDP Feedback Report Poll, for example, and indicate, to STA 1 and STA 2. control signals and transmission timings for UL MU transmission of the feedback information. The control signals may include, for example, information on the transmission of the feedback information, such as a bandwidth, transmission power, allocated RU, MCS, or allocated spatial stream.

STA 1 and STA 2 perform, for example, reception processing on the trigger frames (ST107-1 and ST107-2). STA 1 and STA 2 obtain, for example, the control signals for the UL MU-MIMO transmission of the feedback information by receiving the trigger frames.

STA 1 and STA 2 transmit the feedback information to AP 100, for example, based. on the timings indicated by the trigger frames (ST108-1 and ST108-2). The feedback information may be transmitted by UL MU-MIMO, for example.

AP 100 receives signals (e.g., UL MU-MIMO signals) transmitted from STA 1 and STA 2, and acquires feedback information (ST109).

AP 100 performs scheduling for STA 1 and STA 2, for example, based on the feedback information (ST110). For example, in a case of performing DL MU-MIMO transmission to STA 1 and STA 2, AP 100 may generate a steering matrix based on the feedback information. AP 100 may also perform null-control on the steering matrix in order to reduce interference between feedback information portions, for example.

AP 100 transmits DL MU-MIMO signals (e.g., DL MU PPDUs) to STA I and STA 2 (ST111), For example, AP 100 may transmit the DL MU MIMO signals with the steering matrix added thereto (e.g., reference signals included in preamble portions, and data portions). In addition, AP 100 stores the generated steering matrix in a buffer (not illustrated), for example.

STA 1 and STA 2 perform reception processing on the DL MU-MIMO signals (ST112-1 and ST112-2). For example, STA 1 and STA 2 perform channel estimation based on the reference signals included in the preamble portions of the DL MU-MIMO signals, and extract a signal addressed to each STA 200. In addition, STA 1 and STA 2 may each measure, based on the reference signals included in the preamble portions of the DL MU-MIMO signals, reception quality of the reference signal addressed to the own device (e.g., referred to as a “desired signal”) and of the reference signal addressed to another STA spatially multiplexed in the same RU as the own device (e.g., referred to as an “inter-user interference signal”), for example.

The reception quality may be, for example, an error determination result of the desired signal (i.e., decoding error determination result), SINR of the desired signal, power value of the inter-user interference signal, DUR between the desired signal and the inter-user interference signal, or the amount of change in desired signal power (or inter-user interference signal power) between the previous MU-MIMO signals and the current MU-MIMO signals.

STA 1 and STA 2 determine transmission of feedback information on each stream (i.e., perform feedback determination), for example, based on the measured reception quality (ST113-1 and ST113-2).

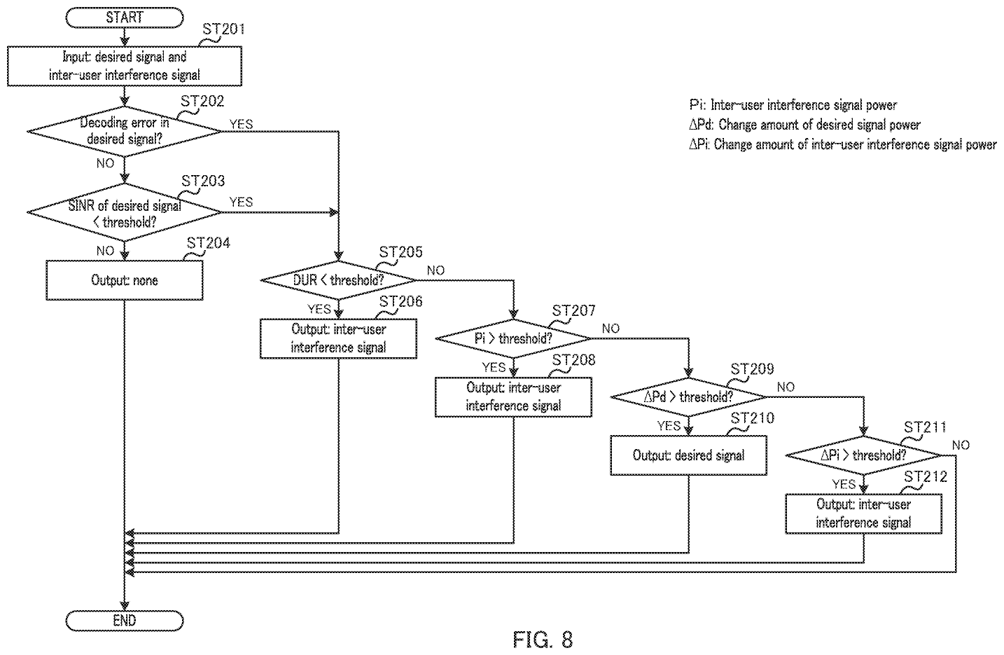

FIG. 8 is a flowchart describing exemplary feedback determination based on the reception quality. By way of example, in FIG. 8, information on the reception quality (e.g., corresponding to the first information) includes an error determination result of a desired signal, SINR of the desired signal, DUR, inter-user interference signal power Pi, change amount ΔPd of desired signal power, and change amount APi of inter-user interference signal power. Note that thresholds respectively corresponding to reception qualities in FIG. 8 may be different from each other.

In FIG. 8, input of the feedback determination processing in STA 200 may include a desired signal and an inter-user interference signal for STA 200 (STA 1 or STA 2), for example (ST201).

For example, STA 200 may determine whether the desired signal includes a decoding error (ST202). When the desired signal includes no decoding error (NO in ST202), STA 200 determines whether the SINR of the desired signal is less than a threshold (ST203).

When the SINR of the desired signal is greater than or equal to the threshold (NO in ST203), STA 200 does not output feedback information (ST204). In other words, STA 200 determines not to transmit feedback information when receiving a desired signal that has no decoding error and has the SINR greater than or equal to the threshold.

Meanwhile, when the desired signal includes a decoding error (YES in ST202) or when the SINR. of the desired signal is less than the threshold (YES in ST203), STA 200 determines whether the DUR is less than a threshold (ST205). When the DUR is less than the threshold (YES in ST205), STA 200 outputs feedback information of the inter-user interference signal (ST206). In other words, when the DUR is less than the threshold, STA 200 determines to transmit the feedback information of the inter-user interference signal causing greater interference to the desired signal.

When the DUR is greater than or equal to the threshold (NO in ST205), STA 200 determines whether inter-user interference signal power Pi is greater than a threshold (ST207). When inter-user interference signal power Pi is greater than the threshold (YES in ST207), STA 200 outputs feedback information of the inter-user interference signal (ST208).

When inter-user interference signal power Pi is less than or equal to the threshold (NO in ST207), STA 200 determines whether change amount ΔPd of desired signal power is greater than a threshold (ST209). When change amount ΔPd of desired signal power is greater than the threshold (YES in ST209), STA 200 outputs feedback information of the desired signal (ST210).

When change amount ΔPd of desired signal power is less than or equal to the threshold (NO in ST209), STA 200 determines whether change amount ΔPi of inter-user interference signal power is greater than a threshold (ST211). When change amount APi of inter-user interference signal power is greater than the threshold (YES in ST211), STA 200 outputs the feedback information of the inter-user interference signal (ST212). Meanwhile, when change amount ΔPi of inter-user interference signal power is less than or equal to the threshold (NO in ST211), STA 200 does not output anything.

As illustrated in FIG. 8, STA 200 determines to feed back stream information on the inter-user interference signal, for example, when the ratio (e.g., DUR) of the desired signal to the inter-user interference signal is less than a threshold, or when the inter-user interference signal power or the amount of change in the inter-user interference signal power is greater than a threshold. Further, STA 200 determines to feed back stream information on the desired signal, for example, when the amount of change in the desired signal power is greater than a threshold.

An exemplary operation of determining (deciding) information to be fed back based on the reception quality has been described, thus far.

As described above, STA 200 (e.g., STA 1 and STA 2) determines the feedback of the stream information based on the information on the reception quality for the desired signal and the inter-user interference signal. The stream information may include, for example, information indicating a destination STA of the spatial stream such as an STA-ID or a spatial stream index, or information indicating an estimation result such as a feedback matrix or an SNR. When the desired signal and the inter-user interference signal include a plurality of spatial streams, for example, STA 200 may perform the above-described feedback determination check the reception quality against the condition) on each spatial stream. According to the feedback determination, STA 200 determines a spatial stream the stream information of which is fed back among the plurality of spatial streams.

Note that, it is assumed in FIG. 7 that STA 1 has stream information to be fed back (Feedback: Yes) and STA 2 has no stream information to be fed back (Feedback: No), by way of example.

In FIG. 7, STA 1 and STA 2 transmit response signals (e.g., Block ACKs) for the DL MU-MIMO signals (ST114-1 and ST114-2). in addition. STA1. which transmits feedback information, newly acquires carrier sense, and transmits the feedback information to AP100, for example, (ST115-1).

Note that the stream information included in the feedback information may be information on a desired signal or information on an inter-user interference signal, for example, as illustrated in FIG. 8. Alternatively, the stream information may be information on a combination of the desired signal and the inter-user interference signal. Further, the stream information included in the feedback information may be, for example, information on all spatial streams the reception qualities of which satisfy predetermined thresholds, or information on some of the spatial streams the reception qualities of which satisfy the predetermined thresholds.

AP 100 performs reception processing on the feedback information transmitted from STA 1 (ST116). For example, AP 100 identifies which of the spatial streams that have addressed to STAs the fed-back stream information corresponds to, based on the STA-ID or the index information of the spatial stream included in the feedback information.

AP 100 performs scheduling processing (ST117). For example, AP 100 may update the steering matrix to be stored based on the feedback information newly acquired from STA 1, and store the steering matrix in a buffer. AP 100 may also change (e.g., update) scheduling of the DL MU-MIMO transmission (e.g, RU allocation or user assignment) based on the feedback information, for example,

AP 100 transmits DL MU-MIMO signals (e.g., including DL MU PPDU) to STA 1 and STA 2, for example, based on the updated steering matrix (ST118).

An exemplary operation of the radio communication system on the DL MU-MIMO transmission has been described, thus far.

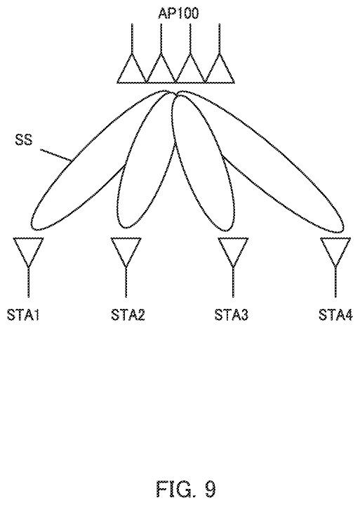

For example, FIG. 9 illustrates a case where single AP 100 including four transmission antennas transmits an MU PPDU in which spatial streams (SSs) are respectively allocated to four STAs 200 (e.g., STA 1 to STA 4) each including a single reception antenna

Each of STAs 1 to 4, for example, performs channel estimation based on reference signals included in the received MU PPDU, and determines whether the reference signals satisfy the conditions on the reception quality (see, for example, FIG. 8) based on the channel estimation result.

Here, from the perspective of certain STA 200, the reference signals used for the channel estimation include a single desired signal for the certain STA 200 and three inter-user interference signals for the other STAs 200. For example, when the reference signals respectively corresponding to the single desired signal and a single inter-user interference signal satisfy the conditions on the reception quality in the certain STA 200, STA 200 transmits, to AP 100, feedback information including stream information on two spatial streams corresponding to those two signals. In other words, STA 200 does not feed back stream information on spatial streams corresponding to the other two signals that do not satisfy the conditions of the reception quality. In this case, for example, the size of the feedback information (e.g., feedback matrix) transmitted by STA 200 is 2×1 (e.g., Nᵣ=2, N=1 in Expression 1) from Expression 1.

Here, if an STA receives an NDP transmitted under the same condition as the MU PPDU in the above-described NDP sounding in FIG. 9, the size of feedback information (e.g., feedback matrix) transmitted by the STA is 4×1 from Expression 1, so that the feedback amount can be reduced in the present embodiment.

Each of STAs 1 to 4 illustrated in FIG. 9 may determine the spatial streams the feedback information of which is transmitted by the operation described above. For example, each of STAs 1 to 4 may transmit the feedback information for all the four spatial streams, or may transmit the feedback information for some of the spatial streams. Further, each of STAs 1 to 4 need not transmit the feedback information for all the spatial streams, for example.

In other words, in multi-user transmission, for example, STAs 1 to 4 may feed back some of stream information portions respectively corresponding to a plurality of spatial streams of a data portion included in a non-NDP MU PPM based on the reception quality of reference signals included in the non-NDP MU PPDU.

This feedback allows each of STAs 1 to 4 to determine the feedback of stream information corresponding to a spatial stream that satisfies the condition on the reception quality, and to determine not to transmit stream information corresponding to a spatial stream that does not satisfy the condition on the reception quality. This reduces overhead of feedback information transmitted from STAs 200. This further reduces the frequency of beamforming processing by NDP sounding, for example.

In addition. STAs 1 to 4 can feed back the stream information at a timing satisfying the condition on the reception quality, in other words, at an appropriate timing to update the steering matrix in AP 100. In other words, STAs 1 to 4 can autonomously determine the timing to feed back the stream information based on the reception quality.

Note that, although FIG. 9 illustrates an example in which STA 200 transmits a feedback matrix on a single desired signal and a single inter-user interference signal, the feedback information need not be related to only these signals On other words, the combination of the signals). For example, in FIG. 9, STA 200 may transmit a feedback matrix on two inter-user interference signals with high signal levels (e,g., reception power) among the three inter-user interference signals, not including the desired signal.

Next, Methods 1-1 to 1-5 will be each described as examples of a method of feeding back stream information by STA 200.

[Method 1-1]

In Method 1-1, STA 200 feeds back stream information to AP 100 by including the stream information in a compressed beamforming/CQI frame Action field format signal.

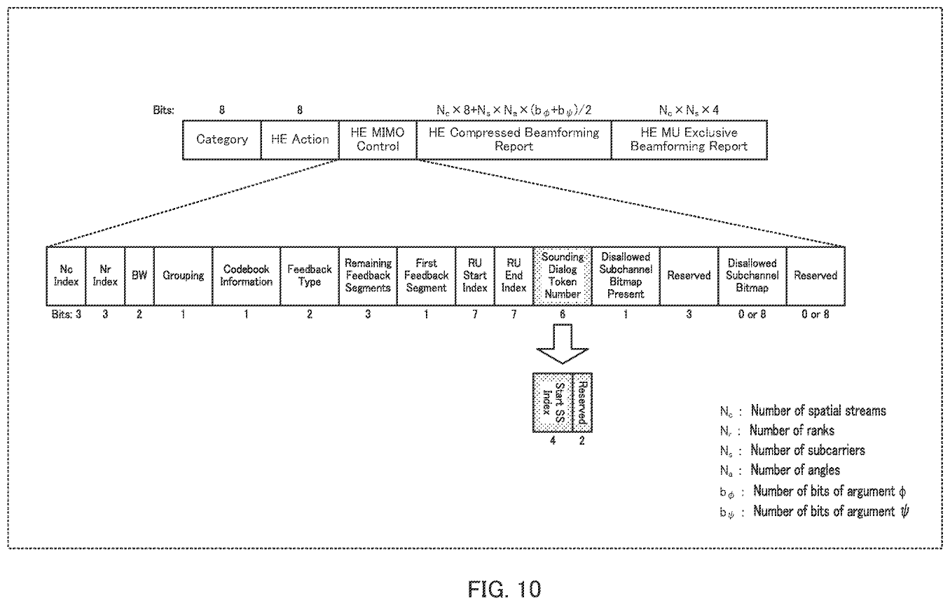

FIG. 10 illustrates an exemplary compressed beamforming/CQI frame action field format for feeding back stream information in Method 1-1.

In Method 1-1, as illustrated in FIG. 10, STA 200 includes a start index (e.g., referred to as a “Start SS index”) among indices of spatial streams corresponding to stream information to be fed back, in the Sounding Dialog Token Number field of the HE MIMO Control field.

In other words, AP 100 and STA 200 read the Sounding Dialog Token Number field of the HE MIMO Control as a Start SS index field.

For example, STA 200 may indicate, to AP 100 by the Start SS index, spatial stream index information corresponding to feedback information (e.g., feedback matrix) on Nc spatial streams. For example, STA 200 may transmit feedback information by including a feedback matrix corresponding to N_{c} spatial streams from the Start SS index to (Start SS index+N_{c}−1). Note that the feedback information may include, for example, a feedback matrix for each tone.

For example, as illustrated in FIG. 10, the feedback information corresponding to N_{c} spatial streams may be included in at least one of the HE Compressed Beamforming Report field and the HE MU Exclusive Beamforming Report field.

In 11ax, for example, an STA feeds back information on N_{c} spatial streams with spatial stream indices from 1 (start) to N_{c}. In Method 1-1, in contrast, STA 200 feeds back information on N_{c}. spatial streams with spatial stream indices from the Start SS index to (Start SS index+N_{c}−1). In other words, STA 200 can determine not to transmit information on spatial streams with spatial stream indices from 1 (start) to (Start SS index—1) in Method 1-1.

Thus, Method 1-1 makes it possible to reduce the feedback amount in the HE Compressed Beamforming Report field or the HE MU Exclusive Beamforming Report filed, for example.

In addition, the Sounding Dialog Token Number field illustrated in FIG. 10 possibly includes, for example, a value obtained by copying a value of Sounding Dialog Token included in an NDPA. In Method 1-1, for example, the NDPA is not transmitted since STA 200 performs feedback determination based on the reception quality of reference signals included in a MU-MIMO signal as illustrated in FIG. 7 (e.g., processing of ST111). Thus, STA 200 can feed back stream information in the compressed beamforming/CQI frame Action field format by reading the Sounding Dialog Token Number field as the Start SS index field, for example.

Note that the area (e.g., field) to which the Start SS index is assigned is not limited to the Sounding Dialog Token Number field, and may be, for example, another field in which part or all of the field is not used in the feedback determination processing.

[Method 1-2]

In Method 1-2, STA 200 feeds back, to AP 100, information specifying the destination STA of a spatial stream, for example. In other words, STA 200 does not feed back feedback information, such as a feedback matrix or SNR, to AP 100 in Method 1-2.

The “information specifying the destination STA of a spatial stream” may include, for example, an “STA-ID” corresponding to STA 200 assigned to the spatial stream the stream information of which is determined to be fed back, or a “spatial stream index (SS index)” corresponding to the spatial stream the stream information of which is determined to be fed back.

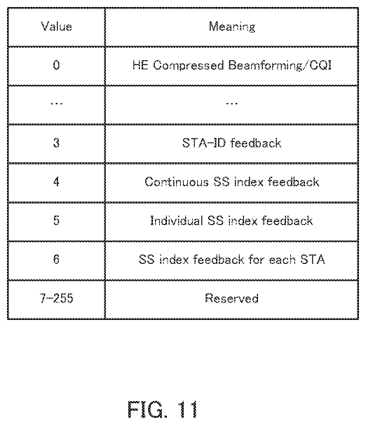

When feeding back the information specifying the destination STA of a spatial stream, STA 200 may apply a frame format according to a value in the “HE Action field” as illustrated in FIG. 11, for example.

For example, when the FIE Action field has a value of 0, STA 200 may apply the HE Compressed Beamforming/CQI frame Action field format illustrated in FIG. 2. When the HE Action field has a value of any of 3 to 6, for example, STA 200 may apply a frame format for feeding back the information specifying the destination STA of a spatial stream.

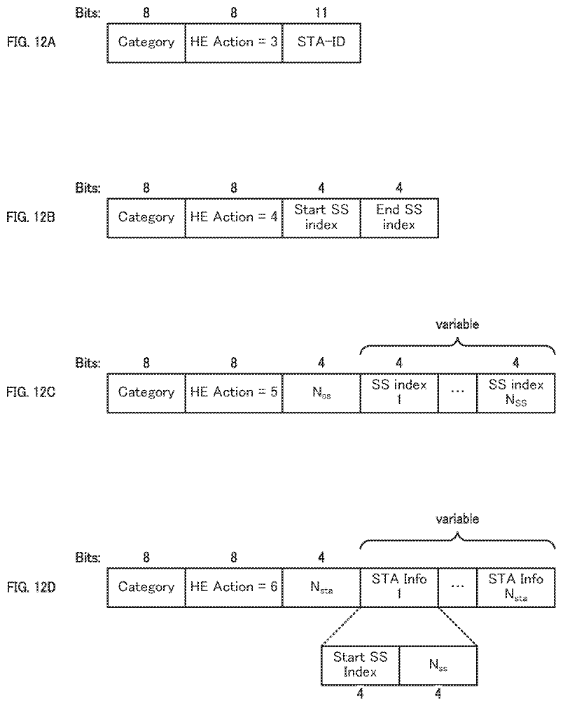

FIGS. 12A to 12D illustrate exemplary frame formats to be applied when the HE Action field has values of 3 to 6 respectively.

FIG. 12A illustrates an example of the frame format “STA-1D feedback frame format” in a case where an STA-ID is included in the information specifying the destination STA of a spatial stream (for example, when the HE Action field has a value of 3).

The frame format illustrated in FIG. 12A includes, for example, the STA-ID of an STA assigned to a spatial stream the stream information of which is determined to be fed back by STA 200. When STA 200 feeds back stream information on one or more spatial streams allocated to a single STA, for example, STA 200 may feed back (i.e., indicate) to AP 100 by including the STA-ID of the corresponding STA in the STA-ID field illustrated in FIG. 12A.

FIG. 12B illustrates an example of the frame format “Continuous SS index feedback frame format” in a case where SS indices are included in the information specifying the destination STA of a spatial stream (for example, when the HE Action field has a value of 4).

The frame format illustrated in FIG. 12B includes, for example, the “Start SS index” indicating the start spatial stream index and the “End SS index” indicating the end spatial stream index among the spatial streams the stream information portions of which are determined to be fed back by STA 200. For example, when STA 200 feeds back stream information portions on a plurality of spatial streams allocated across a plurality of STAs, STA 200 may feed back to AP 100 by respectively including the start and end indices of the SS indices of the corresponding spatial streams in the Start SS index field and the End SS index field illustrated in FIG. 12B.

Note that the continuous stream information portions indicated by the Continuous SS index feedback frame format may specify a plurality of spatial streams across a plurality of STAs 200, or a plurality of spatial streams allocated to single STA 200.

Further, in FIG. 12B, a field indicating the number of spatial streams (e.g., Nₛₛ field to be described later) may be configured, instead of the “End SS index field” indicating the end spatial stream index, for example.

FIG. 12C illustrates an example of the frame format “Individual SS index feedback frame format” in a case where Nₛₛ SS indices are included in the information specifying the destination STA of a spatial stream (for example, when the HE Action field has a value of 5).

The frame format illustrated in FIG. 12C includes, for example, “Nₛₛ” indicating the number of spatial streams the stream information portions of which are determined to be fed back by STA 200, and “SS index 1” to “SS index Nₛₛ” indicating the indices of the Nₛₛ spatial streams.

The Nₛₛ stream information portions indicated by the Individual SS index feedback frame format may specify a plurality of spatial streams across a plurality of STAs 200, or a plurality of spatial streams allocated to single STA 200. In addition, the SS indices of the spatial streams corresponding to the Nₛₛ stream information portions may include continuous values or discontinuous values.

FIG. 12D illustrates an example of the frame format “SS index feedback for each STA frame format” in a case where SS indices for each of Nₛₜₐ STAs are included in the information specifying the destination STA of a spatial stream (for example, when the HE Action field has a value of 6).

The frame format illustrated in FIG. 12D includes, for example, the “STA Info fields” each indicating information on the spatial stream indices for each of Nₛₜₐ STAs. Each STA Info field may include, for example, the “Start SS index field” indicating the start spatial stream index and the “Nₛₛ field” indicating the number of the spatial streams.

For example, STA 200 may feed back to AP 100 by respectively including, for each STA that feeds back the stream information, the start index of the corresponding spatial streams and the number of the streams in the Start SS index field and the Nₛₛ field illustrated in FIG. 12D. In other words, the stream information (e.g., spatial stream indices) for each STA indicated by the Start SS index to (Start SS index+Nₛₛ−1) is indicated to AP 100 for each STA that feeds back the stream information, for example.

Note that, in FIG. 12D, for example, the “End SS index field” indicating the end spatial stream index may be configured as in FIG. 12B, instead of the Nₛₛ field, for example.

In addition, the Category field included in FIGS. 12A to 12D may indicate, for example, a type of the Action frame.

Upon receiving the above-described information specifying the destination STA of a spatial stream, AP 100 may, for example, schedule DL MU-MIMO transmission or update a steering matrix.

For example, as illustrated in FIG. 8, a spatial stream the stream information of which is fed hack may be a spatial stream (or STA) corresponding to a signal that possibly causes interference to a desired signal (e,g., inter-user interference signal).

With this regard, AP 100 may schedule the source STA of feedback information and the STA specified based on stream information (e.g., STA_ID or SS index) included in the feedback information so that the STAs are not user-multiplexed to the same RU, for example.

Further, AP 100 may change the spatial stream index allocated for DL MU-MIMO so as not to use the spatial stream index included in the feedback information (or the spatial stream corresponding to the STA_ID), for example.

In Method 1-2, the feedback information includes information on a spatial stream to be fed back (i.e., information specifying the destination STA of the spatial stream) and information specifying index information (e.g., STA_ID or SS index). In other words, the feedback information does not include information such as a feedback matrix or SNR. Thus, Method 1-2 makes it possible to reduce the feedback amount as compared with a case where the information such as a feedback matrix or SNR is fed back (e.g., a case of using the Compressed beamforming/CQI frame Action field format, which is a feedback format of 11ax), for example.

[Method 1-3]

In Method 1-3, STA 200 transmits feedback information in a response signal (e.g., ACK or Block ACK) or a negative response signal (Negative-ACK (NACK)) for received data (e.g., MU PPDU).

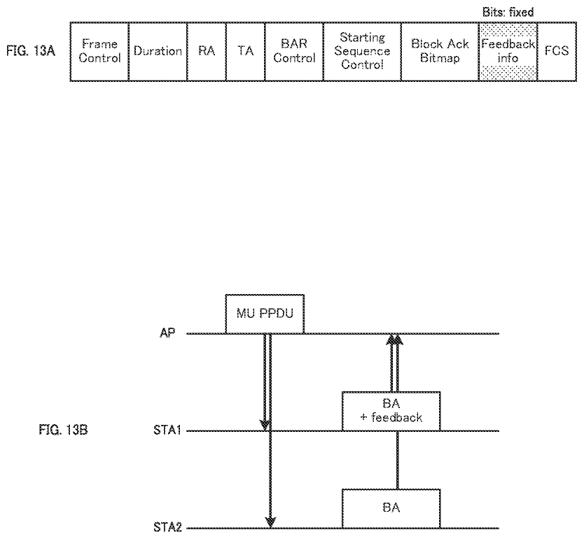

FIG. 13A illustrates an exemplary “BA frame format”, which is a frame format to be applied to the transmission of ACK (or Block ACK) and NACK in Method 1-3.

In the BA frame format illustrated in FIG. 13A includes, for example, fixed-length feedback information in the “Feedback info field”.

STA 200 transmits (e.g., performs UL MU transmission of) a response signal (e.g., BA) in response to an MU PPDU transmitted from AP 100 as illustrated in FIG. 13B, for example. At this time, STA 200 (e.g,, STA 1) may transmit the BA and feedback information in the BA frame format, for example, when having the feedback information to be transmitted. STA 200 (e.g., STA 2), however, need not include feedback information in the Feedback info field of the BA frame format.

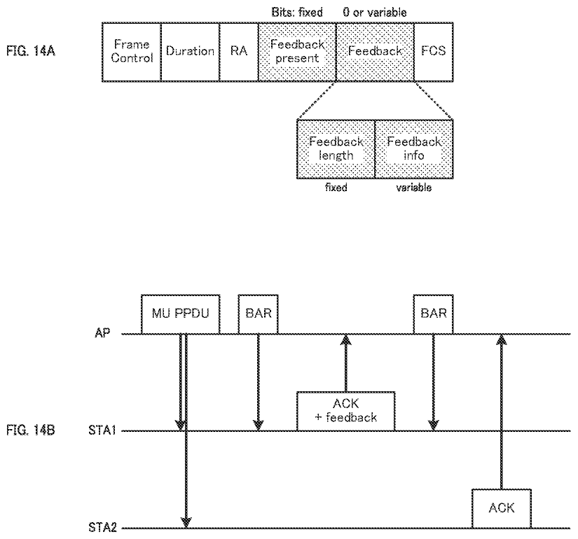

FIG. 14A illustrates an exemplary “ACK frame format”, which is a frame format to be applied to the transmission of ACK (or Block ACK) and NACK in Method 1-3,

The ACK frame format illustrated in FIG. 14A includes, for example, the “Feedback field” indicating variable-length feedback information, The ACK frame format illustrated in FIG. 14A further includes, for example, the “Feedback present field” indicating the presence or absence of the feedback information. The Feedback present field has, for example, a fixed length.

For example, when the Feedback present field indicates the presence of feedback information in the ACK frame format, the Feedback field max include the “Feedback length field” and the “Feedback info filed”. The Feedback length field is, for example, a fixed-length field that indicates the length of the variable-length Feedback info field (e.g., the number of bits). For example, when the Feedback present field does not indicate the presence of feedback information in the ACK frame format, the length of the Feedback field is 0 bit.

STA 200 transmits a signal including the ACK frame format based on a BA request

(BAR) transmitted from AP 100 to each STA 200 (e.g., STA 1 and STA 2), for example, as illustrated in FIG. 14B, in FIG. 14B, for example. STA 1 transmits, to AP 100, an ACK and feedback information in the ACK frame format. Further, in FIG. MB, for example, STA 2 transmits, to AP 100, an ACK in the ACK frame format, without including feedback information.

According to Method 1-3, STA 200 transmits a response signal (or negative response signal) including feedback information (e.g., stream information). Method 1-3 thus allows STA 200 to transmit a response signal and feedback information together to AP 100, thereby reducing overhead of a preamble portion.

[Method 1-4]

In Method 1-4, STA 200 transmits a signal requesting AP 100 to transmit a trigger frame that triggers feedback information transmission by STA 200 (hereinafter referred to as a “Trigger request”). In other words, STA 200 requests AP 100, which is a source of a plurality of spatial streams in multi-user transmission, to transmit a signal that triggers the transmission of feedback information including stream information.

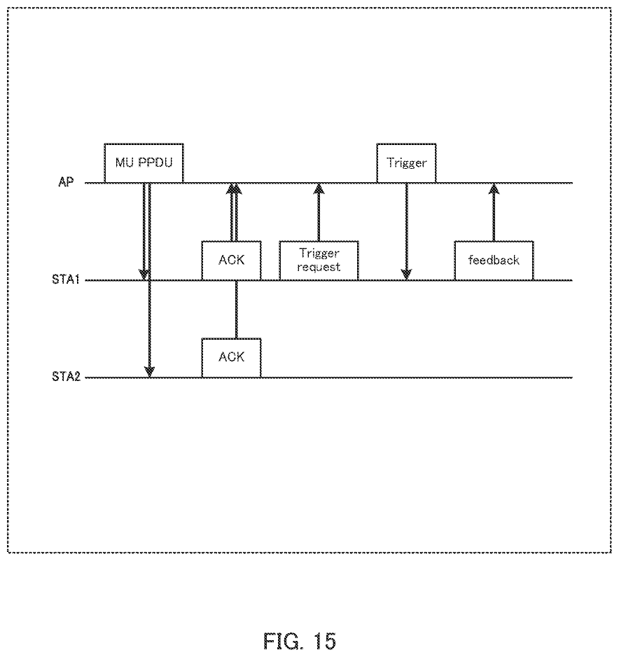

FIG. 15 is a sequence diagram describing exemplary transmission of the Trigger request from STA 200 to AP 100.

STA 200 (e.g., STA 1) transmits the Trigger request to AP 100, for example, when generating feedback information based on an MU PPDU received from AP 100.

Note that the Trigger request may he transmitted, for example, after transmitting a response signal (e.g., ACK) to AP 100. In addition, STA 200 may newly acquire carrier sense and transmit the Trigger request to AP 100, for example.

STA 200 may include, for example, a parameter on the feedback information (e.g., length of the feedback information) in the Trigger request.

Further, STA 200 may transmit the Trigger request in a response signal or negative response signal, for example,.

When receiving the Trigger request, AP 100 transmits a trigger frame requesting feedback information transmission to STA 200 (STA 1 in FIG. 15) from which the Trigger request has been transmitted. The trigger frame may be, for example, a Beamforming report poll. AP 100 may transmit the trigger frame only when receiving Trigger requests from a predetermined number or more of STAs 200.

When receiving the trigger frame transmitted from AP 100, STA 200 transmits the feedback information to AP 100 based on, for example, a control signal included in the trigger frame. The control signal included in the trigger frame may include, for example, information on the feedback information transmission, such as a bandwidth, transmission power, allocated RU, MCS, or allocated spatial stream.

AP 100 may also include, for example, an additional control signal for STA 200 to transmit the feedback information in the trigger frame (e.g., Trigger Dependent Common Info field), for example. The additional control signal may include information such as a feedback type, the number of subcarrier groupings, or the codebook size, for example.

According to Method 1-4, AP 100 can control the transmission timing or transmission parameters of feedback information when STA 200 transmits feedback information, thereby improving reception quality of the feedback information.

[Method 1-5]

In Method 1-5, STA 200 transmits a signal indicating feedback information transmission to AP 100 (hereinafter, referred to as “Feedback present”). In other words, STA 200 indicates the transmission of feedback information including stream information to AP 100, which is a source of a plurality of spatial streams in multi-user transmission.

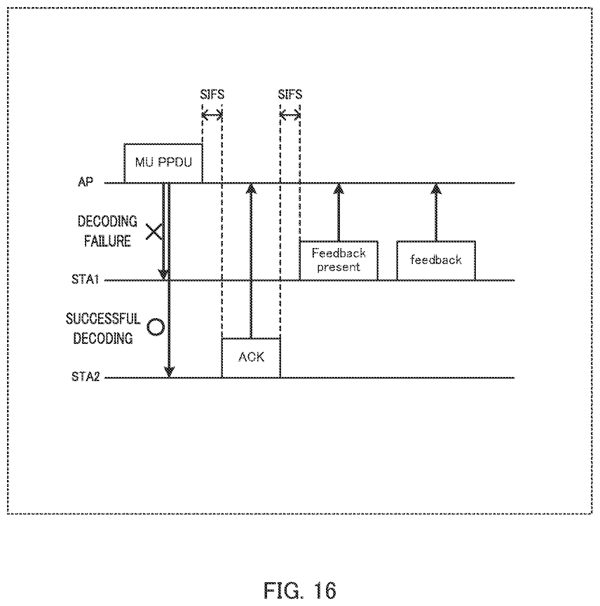

FIG. 16 is a sequence diagram describing exemplary transmission of the Feedback present from STA 200.

Regarding an MU PPDU transmitted from AP 100 in FIG. 16, for example, when a signal addressed to STA 2 causes great interference to a signal addressed to STA 1, STA 1 possibly fails to decode the signal and STA 2 possibly decodes the signal successfully.

At this time, STA 1 may generate feedback information including stream information on a spatial stream corresponding to the signal addressed to STA 2. In Method 1-5, STA 1 transmits Feedback present to AP 100 before transmitting the feedback information. For example, STA 1 may transmit the Feedback present to AP 100 after Short inter-frame space (SITS) from transmission of a response signal (e.g., ACK) to AP 100 by STA 2.

When receiving the Feedback present, for example, AP 100 temporarily stops transmission of an MU-MIMO signal including STA 1 as the destination until a steering matrix is updated based on the feedback information from STA 1. In other words, AP 100 determines that STA 1 is likely to fail the decoding of a MU-MIMO signal addressed to STA I if the signal is transmitted based on the steering matrix held for STA 1, and stops the transmission of a signal to STA 1 until the steering matrix is updated.

STA 1 transmits the feedback information after transmitting the Feedback present. For example, STA 1 may newly acquire carrier sense and transmit the feedback information. Further. STA 1 may include the Feedback present in a response signal or negative response signal.

According to Method 1-5, STA 200 indicates feedback information transmission in advance, and this allows AP 100 to prevent MU-MIMO transmission based on a suboptimal steering matrix (e.g., steering matrix before update). Thus, AP 100 can prevent retransmission causing a decoding error in STA 200, thereby improving system throughput.

Exemplary methods of feeding back stream information by STA 200 have been described, thus far,

As described above, in the present embodiment, STA 200 determines a spatial stream the stream information of which is fed back among a plurality of spatial streams in multi-user transmission, and transmits stream information corresponding to the determined spatial stream.

This stream information transmission ,e., feedback) allows STA 200 to transmit, to AP 100, feedback information corresponding to a spatial stream the actual reception quality of which (e.g., quality measured by STA 200) is possibly different from the reception quality recognized by AP 100, for example. In other words, STA 200 may determine not to transmit feedback information corresponding to a spatial stream the actual reception quality of which is not different from or may be treated to be the same as the reception quality recognized by AP 100, for example. Thus, feedback information transmitted by STA 200 is possibly reduced according to the present embodiment, thereby improving the transmission efficiency.

In addition, STA 200 can transmit feedback information for each spatial stream to AP 100, for example, at a time when the actual reception quality is possibly different from the reception quality recognized by AP 100. Thus, according to the present embodiment, it is possible to reduce transmission of feedback information at a time when, for example, the actual reception quality is the same or may be treated to be the same as the reception quality recognized by AP 100, thereby improving the transmission efficiency.

As described above, the present embodiment makes it possible to improve the transmission efficiency in spatial multiplexing transmission such as MU-MIMO transmission.

### Embodiment 2

[Configuration of Radio Communication System]

A radio communication system according to an embodiment of the present disclosure includes at least one AP 300 and a plurality of STAs 400.

In DL communication (e.g., transmission and reception of DL data), for example, AP 300 (or also referred to as a “downlink radio transmitter”) may perform DL MU-MIMO transmission to the plurality of STAs 400 (or also referred to as “downlink radio receivers”). Each of STAs 400 may, for example, generate feedback information based on a signal transmitted by the DL MU-MIMO (e.g,, DL MU PPDU), and transmit the feedback information to AP 300 (e,g., UL SU transmission or UL, MU transmission),

In the present embodiment, STA 400 feeds back, to AP 300, a channel coefficient on a spatial stream of a single or some inter-user interference signals based on reception quality of a reference signal (e.g., LTF) included in a non-NDP MU PPDU. The channel coefficient is, for example, a component of a channel estimation matrix represented by N_{RX}×Nₛₛ. In addition, the channel coefficient is, for example, part of a subcarrier represented by Nₛ. Note that Ns indicates the number of subcarriers allocated to STA 400.

<Exemplary Configuration of AP 300>

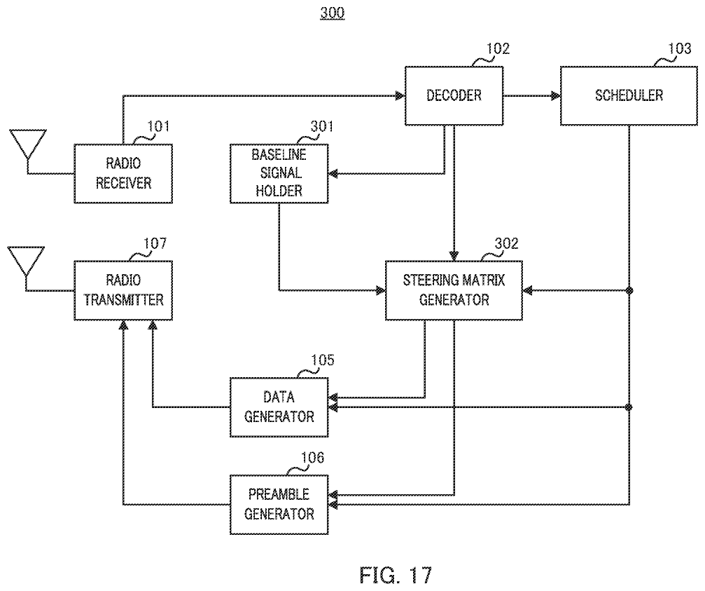

FIG. 17 is a block diagram illustrating an exemplary configuration of AP 300. Note that, in FIG. 17, the same components as in Embodiment 1 (FIG. 5) are denoted by the same reference signs, and the descriptions thereof are omitted.. For example, AP 300 includes baseline signal holder 301 and this is a difference from AP 100 (FIG. 5). Another difference is the operation of steering matrix generator 302, such as the operation on a channel coefficient (or a baseline signal).

When a baseline signal is included in a data signal inputted from decoder 102, baseline signal holder 301 stores the baseline signal in a buffer. Baseline signal holder 301 outputs the baseline signal stored in the butler to steering matrix generator 302 when steering matrix generator 302 updates a steering matrix.

Here, the “baseline signal” nay be any of the channel coefficients included in an estimated channel estimate matrix, for example. For example, a channel coefficient on a desired signal stream with power greater than or equal to a threshold (e.g., maximum power) may be used as the baseline signal. In addition, a channel estimate on a predetermined signal transmitted prior to a reference signal used for channel estimation, for example, may be used as the baseline signal. The predetermined signal may include, for example, a Legacy-short training field (L-STF) or L-LTF, and non-legacy STF. Further, the predetermined signal may be, for example, a signal sequence newly added to a preamble portion.

Steering matrix generator 302 generates a steering matrix based on scheduling information inputted from scheduler 103.

In addition, when a data signal including feedback information (e.g., normalized channel coefficient) is inputted from decoder 102, steering matrix generator 302 may newly generate a steering matrix or may update a part of the held steering matrix, based on the feedback information. When. updating the existing steering matrix based on the feedback information, steering matrix generator 302 may normalize the existing steering matrix based on the baseline signal inputted from baseline signal holder 301, for example, and adjust the amplitude and phase with respect to the feedback information.

<Exemplary Configuration of STA 400>

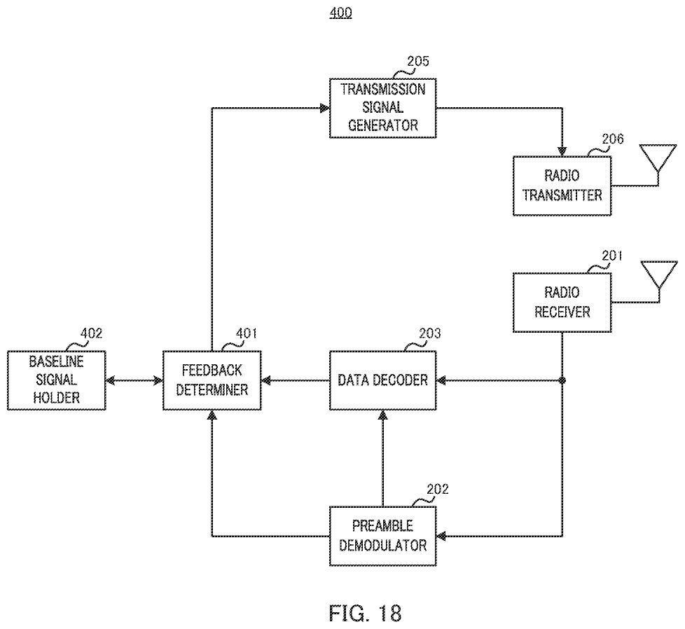

FIG. 18 is a block diagram illustrating an exemplary configuration of STA 400. Note that, in FIG. 18, the same components as in Embodiment 1 (FIG. 6) are denoted by the same reference signs, and the descriptions thereof are omitted. For example, STA 400 includes baseline signal holder 402 and this is a difference from STA 200 (FIG. 6). Another difference is the operation of feedback determiner 401.

Feedback determiner 401 determines whether to feed back information on a spatial stream (e.g., stream information). In other words, feedback determiner 401 determines, for example, a spatial stream the stream information of which is fed hack among a plurality of spatial streams in multi-user transmission.

For example, feedback determiner 401 generates reception quality information based on an error determination result of a data signal inputted from data decoder 203 and a reference signal included in a preamble inputted from preamble demodulator 202.

In addition, feedback determiner 401, for example, determines whether a predetermined threshold (i.e., condition) is satisfied for each of components (e.g., corresponding to channel coefficients) of the reception quality (e.g., channel estimate matrix) generated based on the reference signal.

When the channel coefficient satisfies the predetermined threshold, feedback determiner 401 determines, for example, to feed back (i.e., transmit) the stream information. When the channel coefficient does not satisfy the predetermined threshold, in contrast, feedback determiner 401 determines, for example, not to transmit the stream information. Feedback determiner 401 may, for example, determine whether to feed back the stream information for the channel coefficients on the plurality of spatial streams in the multi-user transmission.

Feedback determiner 401, for example, generates feedback information including the stream information corresponding to the channel coefficient on e determined spatial stream, and outputs the feedback information to transmission signal generator 205.

The feedback information may include, for example, information such as an estimated channel coefficient, a spatial stream index for specifying the channel coefficient, a reception antenna index, a subcarrier index, or an RU index. In addition, the channel coefficient included in the feedback information may be a value relative to a baseline signal, for example. The channel coefficient to be fed back may be a value normalized by a baseline signal, for example,

Feedback determiner 401 adds a baseline signal to the feedback information, for example, when the baseline signal is newly determined. Feedback determiner 401 does not output a signal to transmission signal generator 205 when, for example, there is no reference signal component satisfying a threshold on predetermined reception quality information (i.e., when there is no feedback information). Further, feedback determiner 401 outputs the baseline signal to baseline signal holder 402 when the baseline signal is newly determined.

Baseline signal holder 402 stores the baseline signal inputted from feedback determiner 401 in a buffer. When feedback determiner 401 feeds back a channel coefficient in the feedback information, baseline signal holder 402 outputs the baseline signal stored in the buffer to feedback determiner 401.

[Exemplary Operations of AP and STA]

Next, exemplary operations of AP 300 and STA 400 according to the present embodiment will be described.

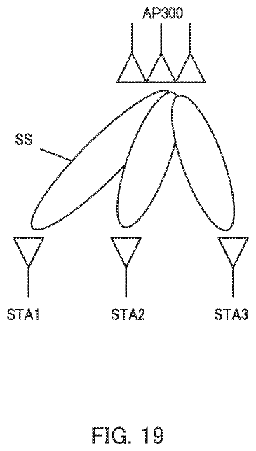

For example, FIG. 19 illustrates a case where single AP 100 including three transmission antennas transmits an MU PPDU in which spatial streams (SSs) are respectively allocated to three STAs 200 (e.g., STA 1, STA 2, and STA 3) each including a single reception antenna

At this time, signals received by STA 1 to STA 3 are represented by following Expression 2, for example:

$$\begin{matrix}( Expression 2 ) & \\ [ \begin{matrix}{y}_{1} \\ {y}_{2} \\ {y}_{3}\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{w}_{11} & {w}_{12} & {w}_{13} \\ {w}_{21} & {w}_{22} & {w}_{23} \\ {w}_{31} & {w}_{32} & {w}_{33}\end{matrix} ] [ \begin{matrix}{x}_{1} \\ {x}_{2} \\ {x}_{3}\end{matrix} ] . & [ 2 ]\end{matrix}$$

Here, “x” represents a transmission signal component, “y” represents a received signal component, “w” represents a steering matrix component, and “h” represents a channel estimate matrix component. For example, received signal component y₁ in STA 1 is represented by following Expression 3:

[3]

y₁=(h₁₁w₁₁+h₁₂w₂₁+h₁₃w₃₁)x₁+(h₁₁w₁₂+h₁₂w₂₂+h₁₃w₃₂)x₂+(h₁₁w₁₃+h₁₂w₂₃+h₁₃w₃₃)x₃ (Expression 3).

The coefficients of the transmission signal components x₁, x₂ and x₃ in Expression 3 are effective channel coefficients. The effective channel coefficients are respectively defined in, for example, following Expression 4, :Expression 5 and Expression 6:

[4]

h₁₁w₁₁+h₁₂w₂₁+h₁₃w₃₁=h_{eff}_{₁₁} (Expression 4);

[5]

h₁₁w₁₂+h₁₂w₂₂+h₁₃w₃₂=h_{eff}_{₁₂} (Expression 5); and

[6]

h₁₁w₁₃+h₁₂w₂₃+h₁₃w₃₃=h_{eff}_{₁₃} (Expression 6).

According to Expression 4, Expression 5 and Expression 6, channel coefficient h₁₃ is represented by following Expression 7, for example:

$$\begin{matrix}( Expression 7 ) & \\ {h}_{13} = \frac{\begin{matrix}{h}_{{eff}_{11}} ( {w}_{12} {w}_{23} - {w}_{13} {w}_{22} ) + \\ {h}_{{eff}_{12}} ( {w}_{13} {w}_{21} - {w}_{11} {w}_{23} ) + {h}_{{eff}_{13}} ( {w}_{12} {w}_{21} + {w}_{11} {w}_{22} )\end{matrix}}{\begin{matrix}{w}_{11} ( {w}_{23} {w}_{32} + {w}_{22} {w}_{33} ) + \\ {w}_{12} ( {w}_{23} {w}_{31} - {w}_{21} {w}_{33} ) + {w}_{13} ( {w}_{21} {w}_{32} - {w}_{22} {w}_{31} )\end{matrix}} . & [ 7 ]\end{matrix}$$

From Expression 7, channel coefficient h₁₃ is derived, for example, by the known steering matrix and the effective channel coefficients (e.g., h_{eff11}, h_{eff12}, and h_{eff13}). Note that the other channel coefficients h₁₁ and h₁₂ can also be derived in the same manner as Expression 7.

For example, it is assumed by measurement of reference signals of the MU PPDU received by STA 1 illustrated in FIG. 19 that a reference signal corresponding to an inter-user interference signal addressed to STA 2 has high power (e.g., greater than or equal to a threshold) and a reference signal corresponding to an inter-user interference signal addressed to STA 3 has low power (e.g., less than the threshold). In this case, for example, STA 1 may determine to feed back stream information on the inter-user interference signal addressed to STA 2.

For example, STA 1 normalizes, based on a baseline signal, effective channel coefficient h_{eff12} for the inter-user interference signal of STA 2 among effective channel coefficients obtained by channel estimation. STA I may then transmit, to AP 300, feedback information including normalized effective channel coefficient h′_{eff12} and the baseline signal.

AP 300 acquires normalized effective channel coefficient h′_{eff12} and the baseline signal from the feedback information received from STA 1. AP 300 separates the steering matrix based on normalized effective channel coefficient h′_{eff12}, and derives a channel estimate (e.g., channel coefficient h₁₃).

At this time, AP 300 determines, for example, that effective channel coefficient ham for a desired signal, which is not included in the feedback information, has smaller variation due to propagation path variation than effective channel coefficient h_{eff12} does. Then. AP 300 may derive effective channel coefficient hemi for the desired signal (see, for example. Expression 4) using, for example, channel coefficients (e.g., h₁₁, h₁₂, and h₁₃) obtained by the last NDP sounding and the known steering matrix (e.g., including w₁₁, w₂₁, and w₃₁).

In addition, AP 300 may treat |h_{eff13}| as approximately 0 because, for example, the inter-user interference signal of STA 3, which is not included in the feedback information, is sufficiently interference-suppressed by effective channel coefficient h_{eff13}.

As described above, regarding the derivation of channel coefficient h13 given in Expression 7, for example, AP 300 can derive channel coefficient h13 based on effective channel coefficient h_{eff12} (e.g., normalized effective channel coefficient h′_{eff12}) of one fed-back inter-user interference signal, the known channel coefficients, and the known steering matrix. AP 300 may derive other channel coefficients in the same manner as the derivation of channel coefficient h₁₃.

AP 300 may newly calculate, for example, a steering matrix component based on a derived channel coefficient. For example, the newly calculated steering matrix component may be a component that suppresses interference caused by a signal addressed to STA 2 to a signal addressed to STA 1.

AP 300 then updates the steering matrix based on the calculated steering matrix component. At this time, AP 300 may adjust at least one of the phase and amplitude between the newly calculated steering matrix component and the existing steering matrix by normalizing the existing steering matrix based on the baseline signal.

In the present embodiment, for example, STA 400 generates feedback information based on a channel coefficient (e.g., effective channel coefficient) for some signals (e.g., inter user interference signals) among channel estimates (e.g., channel estimate matrix) for spatial streams in multi-user transmission. In other words, STA 400 transmits, to AP 300, feedback information including some components (effective channel coefficient h′_{eff12} in the above example) of the channel estimates for the spatial stream, for example.

Generating feedback information in such a manner reduces overhead of feedback information compared to, for example, feeding back a channel estimate per spatial stream. For example. STA 400 only needs to generate feedback information including a single effective channel coefficient per tone or group tone when the amount of the feedback information is minimized, thereby reducing overhead of the feedback information,

In addition, STA 400 can directly acquire an effective channel coefficient on the basis of a reference signal included in a non-NDP MU PPDU transmitted from AP 300, for example, and this allows STA 400 to easily generate feedback information.

Further, STA 400 feeds back, to AP 300, a value obtained by normalizing an effective channel coefficient by a predetermined value (e.g., baseline signal) and the baseline signal. The feedback of the normalized value allows AP 300 to adjust the amplitude and phase between the feedback information and held information (e.g., steering matrix component) when updating the steering matrix, for example.

Next, Method 2-1 will be described as an exemplary method of feeding back stream information by STA 400.

[Method 2-1]

In Method 2-1, STA 400 quantizes a channel coefficient (e.g., channel estimate component) normalized by a baseline signal in an amplitude range narrower than the amplitude of the baseline signal.

For example, the channel coefficient normalized by, the baseline signal indicates the relative amplitude to the baseline signal (i.e., difference from the baseline signal).

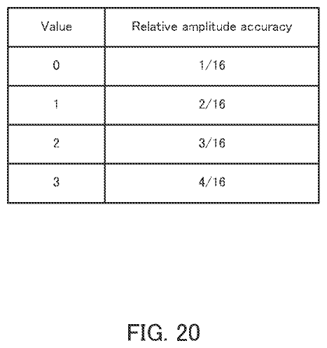

FIG. 20 illustrates an exemplary range of the relative amplitude corresponding to channel coefficients. In FIG. 20, the expression range of the relative amplitude to the baseline signal is set from 0 to ¼, for example. The values 0 to 3 of the relative amplitude respectively indicate, for example, four patterns of amplitude accuracy (i.e., granularity), which are 1/16, 2/16, 3/16, and 4/16.

As described above. STA 400 may set the relative amplitude accuracy (i.e., expression range) to variable depending on, for example, the value of the normalized channel coefficient (e.g., relative amplitude), and quantize the normalized channel coefficient based on the set relative amplitude accuracy.

For example, STA 400 may set a smaller value for the relative amplitude accuracy when the value of the relative amplitude is smaller (in other words, when the difference between the normalized channel coefficient and the baseline signal is smaller). This setting allows STA 400 to quantize the normalized channel coefficient with finer granularity as the value of the relative amplitude is smaller, for example, when the normalized channel coefficient is assigned a fixed number of bits, for example. In other words, STA 400 can quantize the normalized channel coefficient in a wider range with coarser granularity as the value of the relative amplitude is greater, for example.

STA 400 may feed back to AP 300, for example, including the relative amplitude accuracy (e.g., any of the values 0 to 3 illustrated FIG. 20) and the channel coefficient together in the feedback information.

Further, STA 400 may set the relative amplitude accuracy smaller for each feedback when feeding back a component of an inter user interference signal in a plurality of times for the same channel coefficient, for example. This setting of the relative amplitude accuracy may gradually correct, for example, a suppressing effect of a steering matrix on the inter-user interference signal,

Method 2-1 allows the amplitude of a channel coefficient, which is a relative value, to be represented by a smaller number of bits with high accuracy, and AP 300 can thus improve the accuracy of correcting a steering matrix.

Embodiments of the present disclosure have been each described, thus far.

### Other Embodiments

1. Any two or more of Methods 1-1 to 1-5 and Method 2-1 may be combined.

For example, in a case where Method 1-1 and Method 1-2 are combined, a transmission signal fed back by an STA may include both the compressed beamforming/CQI frame Action field format and the Individual SS index feedback frame format in the data portion. At this time, STA 200 may indicate, to AP 100, index information of a spatial stream to be fed back using the Individual SS index feedback frame format, without reading the Sounding Dialog Token Number field as the Start SS index as in Method 1-1. This indication method allows, for example, the spatial stream index to be specified discretely (i.e., discontinuously), thus reducing the amount of feedback.

Note that, although Method 1-1 and the Individual SS index feedback frame format in Method 1-2 are combined by way of example here, another frame format may be used for indicating the spatial stream index.

2. Methods 1-1 to 1-5 and Method 2-1 may be applied in a case where an STA transmits feedback information to a plurality of APs in Multi-AP coordination.

3. Methods 1-1 to 1-5 and Method 2-1 may be applied to not only transmission of feedback information for a non-NDP PPDU, but for an NDP.

4. In a case where an AP controls a plurality of DL MU-MIMO transmissions, the AP may transmit an identifier (e.g., referred to as an “MU-MIMO ID”) for specifying an allocation pattern of the MU-MIMO in a DL MU-MIMO signal (e.g., User field of the preamble).

At this time, an STA may acquire the MU-MIMO ID from the received DL MU-MIMO signal, for example, and transmit the MU-MIMOM in feedback information. This allows the AP to determine which DL MU-MIMO signal the feedback information corresponds to, based on the MU-MIMO ID included in the feedback information.

5. An STA may transmit feedback information to an AP at a time, or may divide feedback information into a plurality of transmission frames to transmit to an AP.

6. An STA may preferentially feed back information of at least one of a desired signal and an inter-user interference signal the feedback information of which have not been transmitted for a certain time period.

7. In Embodiments 1 and 2, an STA may determine stream information to be fed back according to a condition other than the reception quality, in addition to the reception quality of a reference signal included in a non-NDP PPDU.

For example, the STA determines, for each spatial stream, the predetermined conditions on the reception quality of a reference signal and the condition other than the reception quality, and feeds back information on the spatial streams that satisfy all the conditions.

The condition other than the reception quality may be, for example, a feedback interval. The feedback interval may be the number of non-NDP MU PPDU packets received since the last feedback transmission by the STA. The feedback interval may also be time elapsed since the last feedback transmission by the STA. The STA performs feedback transmission when a predetermined feedback interval has elapsed. The STA determines not to perform feedback transmission when the predetermined feedback interval has not elapsed.

The condition other than the reception quality may he, for example, an MCS in a data portion of a non-NDP PPDU. The STA may increase the feedback frequency when the MCS level in the data portion obtained from a preamble portion of the non-NDP PPDU is greater than a predetermined MCS level. The STA may decrease the feedback frequency when the MCS level in the data portion obtained from the preamble portion of the non-NDP PPDU is less than the predetermined MCS level.

The condition other than the reception quality may be, for example, the number of spatial streams allocated to the STA. The STA may decrease the feedback frequency when the number of allocated spatial streams is greater than a predetermined number of allocated spatial streams, The STA may increase the feedback frequency when the number of allocated spatial streams is less than the predetermined number of allocated spatial streams.

The condition other than the reception quality may be, for example, the upper limit number of spatial streams to be transmitted in a single feedback. In a case where M spatial streams satisfy the predetermined conditions on the reception quality of a reference signal, the STA limits the spatial streams to be fed back based on the upper limit number N (where M>N) of the spatial streams to be fed back.

The condition other than the reception quality may be, for example, the minimum number of spatial streams required for feedback. The STA performs feedback only when N or more spatial streams satisfy the predetermined conditions on the reception quality of a reference signal. The STA determines not to perform feedback transmission when less than N spatial streams satisfy the predetermined conditions on the reception quality of a reference signal.

The condition other than the reception quality may be determined based on the capability of the STA, for example. In addition, an AP may indicate the condition other than the reception quality to the STA by including the condition in an NDPA, beacon, management frame, etc.

The STA may control a threshold of the reception quality information according to the condition other than the reception quality. Further, the STA may control the condition other than the reception quality according to the reception quality information.

8. In the above embodiments, the exemplary configuration based on the 11ax frame format has been described by way of example, but the format to which an embodiment of the present disclosure is applied is not limited to the 11ax format.

9. Although an operation in DL communication has been described in the above embodiments, an embodiment of the present disclosure may be applied to not only the DL communication but also UL communication or sidelink, for example.

10. The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could he integrated using the future integrated circuit technology. Biotechnology can also he applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A communication apparatus according to an embodiment of the present disclosure includes: control circuitry, which, in operation, determines a spatial stream based on first information, the spatial stream being subject to feedback on second information, and the first information being information on reception quality of a plurality of spatial streams including the spatial stream; and transmission circuitry, which, in operation, transmits the second information on the determined spatial stream.

In an embodiment of the present disclosure, the second information includes information on some of the plurality of spatial streams,

In an embodiment of the present disclosure, the second information is included in a compressed beamforming/CQI frame Action field format signal.

In an embodiment of the present disclosure, the second information includes information identifying a terminal assigned to the determined spatial stream,

in an embodiment of the present disclosure, the second information includes information identifying the determined spatial stream.

In an embodiment of the present disclosure, the second information is included in a response signal for received data

In an embodiment of the present disclosure, the transmission circuitry requests a source of the plurality of spatial streams to transmit a signal that triggers transmission of the second information.

In an embodiment of the present disclosure, the transmission circuitry transmits a signal that indicates transmission of the second information to a source of the plurality of spatial streams.

In an embodiment of the present disclosure, the second information includes a value resulting from normalizing some components of a channel estimate for each of the plurality of spatial streams by a baseline signal.

In an embodiment of the present disclosure, the control circuitry quantizes the normalized components of the channel estimate in an amplitude range narrower than an amplitude of the baseline signal.

A communication method according to an embodiment of the present disclosure includes: determining, lav a communication apparatus, a spatial stream based on first information, the spatial stream being subject to feedback on second information, and the first information being information on reception quality of a plurality of spatial streams including the spatial stream; and transmitting, by the communication apparatus, the second information on the determined spatial stream.

The disclosure of Japanese Patent Application No. 2019-166253, filed on Sep. 12, 2019, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100, 300 AP
101, 201 Radio receiver
102 Decoder
103 Scheduler
104, 302 Steering matrix generator
105 Data generator
106 Preamble generator
107, 206 Radio transmitter
200, 400 STA
202 Preamble demodulator
203 Data decoder
204, 401 Feedback determiner
205 Transmission signal generator
301, 402 Baseline signal holder

1. A communication apparatus, comprising:
control circuitry, which, in operation, determines a spatial stream based on first information, the spatial stream being subject to feedback on second information, and the first information being information on reception quality of a plurality of spatial streams including the spatial stream; and
transmission circuitry, which, in operation, transmits the second information on the determined spatial stream,

2. The communication apparatus according to claim 1, wherein the second information includes information on some of the plurality of spatial streams.

3. The communication apparatus according to claim 1, wherein the second information is included in a compressed beamforming/CQI Action field format signal.

4. The communication apparatus according to claim 1, wherein the second information includes information identifying a terminal assigned to the determined spatial stream.

5. The communication apparatus according to claim 1, wherein the second information includes information identifying the determined spatial stream.

6. The communication apparatus according to claim 1, wherein the second information is included in a response signal for received data

7. The communication apparatus according to claim 1. wherein the transmission circuitry requests a source of the plurality of spatial streams to transmit a signal that triggers transmission of the second information.

8. The communication apparatus according to claim 1, wherein the transmission circuitry transmits a signal that indicates transmission of the second information to a source of the plurality of spatial streams,

9. The communication apparatus according to claim 1, wherein the second information includes a value resulting from normalizing some components of a channel estimate for each of the plurality of spatial streams by a baseline signal.

10. The communication apparatus according, to claim 9, wherein the control circuitry quantizes the normalized components of the channel estimate in an amplitude range narrower than an amplitude of the baseline signal.

11. A communication method, comprising:
determining, by a communication apparatus, a spatial stream based on first information, the spatial stream being subject to feedback on second information, and the first information being information on reception quality of a plurality of spatial streams including the spatial stream; and
transmitting, by the communication apparatus, the second information on the determined spatial stream.
